(19) United States
(12) Patent Application Publication
(10) Pub. No.: US 2016/0131241 A1
(43) Pub. Date: May 12, 2016

(54) BEVEL GEAR OR HYPOID GEAR HAVING CONICAL TOOTH SHAPE IN THE LONGITUDINAL DIRECTION AND HAVING CONSTANT TOOTH GAP WIDTH IN THE BASE

(71) Applicant: Klingelnberg AG, Zurich (CH)

(72) Inventors: Hartmuth Müller, Remscheid (DE); Carsten Hünecke, Hessisch Oldendorf (DE)

(21) Appl. No.: 14/938,220

(22) Filed: Nov. 11, 2015

(30) Foreign Application Priority Data
Nov. 12, 2014 (DE) 202014105422.7

(51) Int. Cl. F16H 55/17

(52) U.S. Cl. CPC F16H 55/17

(57) ABSTRACT

A bevel gear or hypoid gear (10) having spiral gear teeth, which have at least one tooth gap (11), wherein the tooth gap (11) is delimited by tooth flanks (12.1, 12.2), each of the tooth flanks (12.1, 12.2) has a flank longitudinal line in the form of an epicycloid, and the tooth gap (11) has a tooth gap base width which is constant.

### CROSS-REFERENCE TO RELATED APPLICATION

This application claims priority to German application no. DE 20 2014 105 422.7 filed Nov. 12, 2014, which is hereby expressly incorporated by reference as part of the present disclosure.

### FIELD OF THE INVENTION

The subject matter of the invention are spiral-toothed bevel gears and hypoid gears.

### BACKGROUND OF THE INVENTION

There are various types of bevel gears and hypoid gears.

Spiral-toothed bevel gears and spiral-toothed hypoid gears are produced using milling or grinding methods. So-called cutter heads are used in the case of milling and so-called cup grinding wheels are used in the case of grinding. Greatly varying methods are known in this case, which are either single indexing (by grinding or milling) or continuous indexing (only milling).

Circular-arc-toothed bevel gears are manufactured, for example, in the single indexing method (also called the intermittent indexing method or, in the case of spiral bevel gears, face milling). In the single indexing method, the cutters of a cutter head complete a circular movement while one gap of the bevel gear to be generated is manufactured. To manufacture further tooth gaps, the cutter head is retracted and the workpiece is rotated by an indexing angle (called indexing rotation). The next gap is then manufactured accordingly. Therefore, one tooth gap is always manufactured all at once.

By way of the milling using a cutter head, bevel gears having variable tooth height, i.e., the height of the tooth varies continuously along the tooth width, or having constant tooth height can be produced. The variable tooth height is the more typical tooth shape in this case. The resulting flank line on the so-called crown gear is a circular arc in this case.

Epicycloidally-toothed bevel gears, in contrast, are manufactured by continuous indexing, i.e., by a continuous indexing method (referred to as a continuous indexing method or, in the case of spiral bevel gears, face hobbing). In this continuous indexing method, both the cutter head and also the workpiece rotate in a coupled manner in a movement sequence which is chronologically adapted to one another. The indexing is thus performed continuously and tooth gaps and the corresponding teeth are generated quasi-simultaneously.

If gear teeth are milled in the continuous indexing method, the flank line of the epicycloidally toothed bevel gears is an epicycloid. Thus, lengthened or shortened epicycloid flank lines can also be generated. In the case of the presently applied continuous indexing method, the teeth are always embodied having constant tooth height.

Therefore, the respective variables, which determine the geometry, of the manufactured bevel gears or hypoid gears result from the selected method. These variables are, for example, the profile of the flank longitudinal line, the profile of the tooth height along the tooth width, the size of head cone angle and base cone angle, and also the tooth gap base width and the profile thereof.

Bevel gears and hypoid gears having constant tooth height and a circular arc or an epicycloid as the flank longitudinal line shape in general have a conical tooth gap base, i.e., the tooth gap base width is variable.

In the case of bevel gears having variable tooth height, the tooth gap is also conical in the general case.

However, if the base cone angle and the head cone angle are adapted appropriately (so-called duplex cone, see ISO 10 300; the formula which is specified therein only applies for single indexing methods), the tooth gap base width is constant in normal section. This has the advantage that the tooth gaps of such a bevel gear can be manufactured in one cut using a machine setting for the concave and convex flanks. This method is also called completing. The required base cone angles are dependent in this case, for example, on the selected mean spiral angle and on the tool radius. The maximum possible tooth base rounding can be generated in this case over the entire tooth width. The tooth base rounding is also determined by the rounding off radius of the tool. If the tooth gap is now conical, the size of the head width of the tool and therefore also this rounding radius on the tool are thus oriented to the narrowest gap.

In summary, it can be stated that bevel gears having circular-arc-shaped flank longitudinal line (on the crown gear) are usually embodied having variable tooth height and conical or constant tooth gap, while bevel gears having epicycloidal flank longitudinal line (on the crown gear), as arise in the case of continuous methods, are embodied having constant tooth height and conical tooth gap.

Further possibilities are manufacturing in free-form milling by means of a ball cutter or end mill or using a hob cutter in the form of a truncated cone. In the latter method, gear teeth are generated having involutes as the flank longitudinal line and having constant tooth height.

### SUMMARY OF THE INVENTION

The object of the present invention is to provide bevel gears and hypoid gears, which are simple and/or efficient to produce and which are to be as durable as possible.

The invention relates to bevel gears and hypoid gears having spiral gear teeth.

According to certain embodiments, the base cone angle and head cone angle are selected or ascertained so that the tooth gap base width in normal section and therefore the distance of the epicycloids in the gap base in the normal section is constant from the concave and convex flanks. This statement also applies for lengthened and shortened epicycloids.

The advantages of the epicycloidal flank longitudinal line (i.e., the producibility in the continuous method) are combined with the advantages of a constant gap width. The constant gap width enables a maximum tooth base radius to be formed.

In the case of milling using a cutter head, the shape of the epicycloid, with otherwise identical bevel gear geometry parameters, is dependent on the cutter head radius and the cutter head gear number of the cutter head. This means that the base cone angle and the head cone angle can be determined in dependence on the cutter head radius and the cutter head gear number. Or, with predefined cone angle, the required cutter head of the cutter head can be determined.

It is an advantage of the bevel gears and hypoid gears of the invention that they are relatively stable. The teeth frequently break off at the tooth base in gear wheels. The tooth base carrying capacity is higher according to the invention, since greater tooth base rounding is possible.

### BRIEF DESCRIPTION OF THE DRAWINGS

Further details and advantages of the invention are described hereafter on the basis of exemplary embodiments and with reference to the drawing.

FIG. 1 shows a schematic view of two teeth and a tooth gap of a spiral-toothed bevel gear or hypoid gear, wherein the tooth gap was ascertained artificially by concatenating a large number of normal sections.

FIG. 2 shows a perspective view of a bevel pinion or hypoid pinion.

FIG. 3 shows a perspective view of a bevel crown wheel or hypoid crown wheel.

FIG. 4A shows a schematic normal section through the generating crown gear at a 20% tooth width.

FIG. 4B shows a schematic normal section through the generating crown gear at a 50% tooth width.

FIG. 4C shows a schematic normal section through the generating crown gear at a 80% tooth width.

FIG. 5A shows a schematic transverse section through a generated tooth gap of a pinion at a 20% tooth width.

FIG. 5B shows a schematic transverse section of the pinion of FIG. 5A at a 50% tooth width.

FIG. 5C shows a schematic transverse section of the pinion of FIG. 5A at an 80% tooth width.

### DETAILED DESCRIPTION OF EMBODIMENTS OF THE INVENTION

Terms are used in conjunction with the present description which are also used in relevant publications and patents. However, it is to be noted that the use of these terms is only to serve for better comprehension. The concept of the invention and the scope of protection of the patent claims are not to be restricted in the interpretation by the specific selection of the terms. The invention may be readily transferred to other term systems and/or technical fields. The terms are to be applied accordingly in other technical fields.

Bevel gears and hypoid gears 10 have spiral gear teeth. For the sake of simplicity, sometimes only gear wheels 10 are referred to hereafter.

Bevel gears which are designed for installation in a transmission with axial offset are referred to as hypoid gears. The hypoid gear is a form of the spiral bevel gear. The pinion and crown wheel axes of hypoid gears 10 do not run together in a point. The axes do not intersect as in the case of bevel gears, but rather they intersect in the case of hypoid gears.

Spiral gear teeth are gear teeth in which the flank longitudinal line has a curved profile. The radius of curvature of the flank longitudinal line may be less than 20 times the tooth width, i.e., the curvature thereof is correspondingly large.

The tooth width is defined as the section of the indexing cone jacket line between the outer and the inner end faces of the teeth of the bevel gear 10.

For a linear-toothed bevel gear, the transverse section is identical to the normal section. However, in the bevel gears and hypoid gears 10 having spiral gear teeth, the transverse sections also differ from the normal sections.

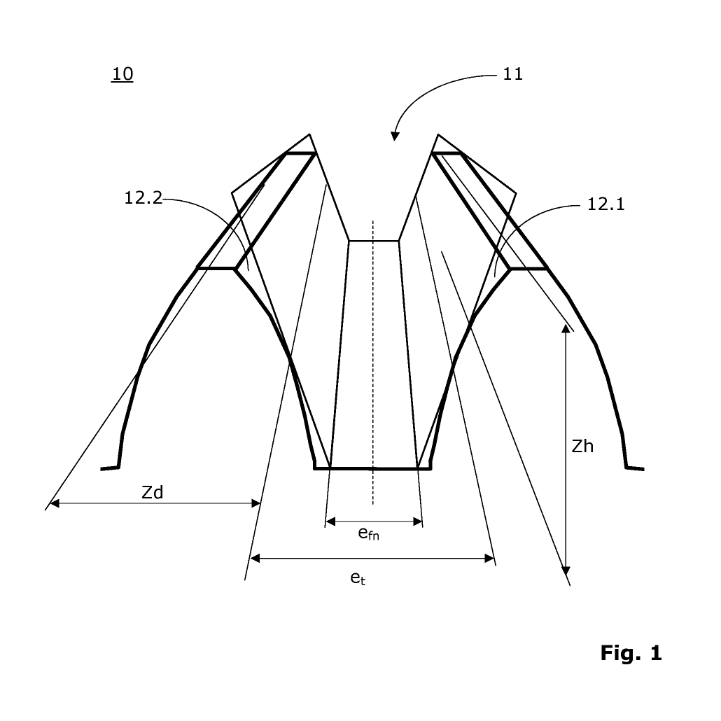

FIG. 1 shows a schematic illustration of gear teeth of a bevel gear 10, which has two teeth on the right and left of a tooth gap 11. The illustration of FIG. 1 is derived from the ISO23509 standard. To be able to depict the spiral gear teeth in this form, the spiral gear teeth were decomposed by computer into a very large number of normal sections and these normal sections were laid one behind another in the style of transverse sections. The following terms are defined as follows according to this standard: tooth thickness Zd; tooth height Zh; tooth gap base width in the tooth base of the crown wheel e_{fn}; tooth gap width in the indexing cone plane eₜ. The indexing cone and the indexing cone plane are important reference variables of a bevel gear 10. Thus, for example, the tooth thickness Zd is defined on the indexing circle, as can be seen in FIG. 1.

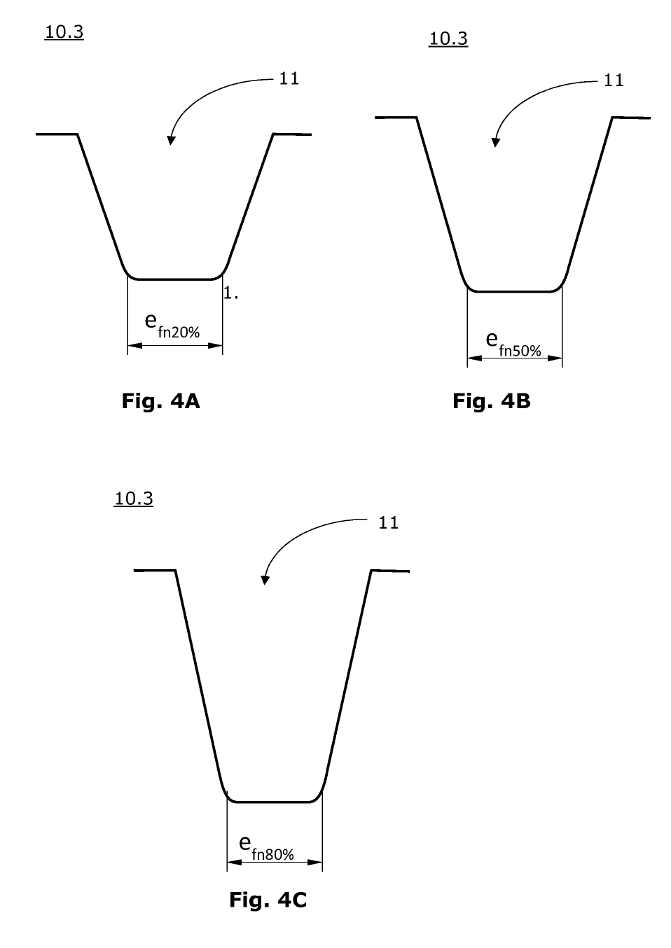

The profile or the shape of the tooth flanks 12.1, 12.2 is described by the flank longitudinal line. The flank longitudinal line of the corresponding generating crown wheel of the bevel gear gear teeth has the form of an epicycloid or it is derived from an epicycloid. The tooth gaps 11 of the generating crown wheel 10.3 are shown in FIGS. 4A to 4C, wherein FIG. 4A shows a tooth gap 11 at the 20% tooth width, FIG. 4B shows a tooth gap 11 at the 50% tooth width (i.e., in the tooth middle), and FIG. 4C shows a tooth gap 11 at the 80% tooth width. It may be recognized on the basis of FIGS. 4A to 4C that the tooth gap base width e_{fn} of the crown wheel 10.3 is equal in the normal section at every position of the tooth width. I.e., the following relationship applies: e_{fn20%}=e_{fn50%}=e_{fn80%}.

The generating crown wheel 10.3 is a bevel crown wheel, which can be used in the pairing with a counter wheel instead of the bevel gear 10 observed here.

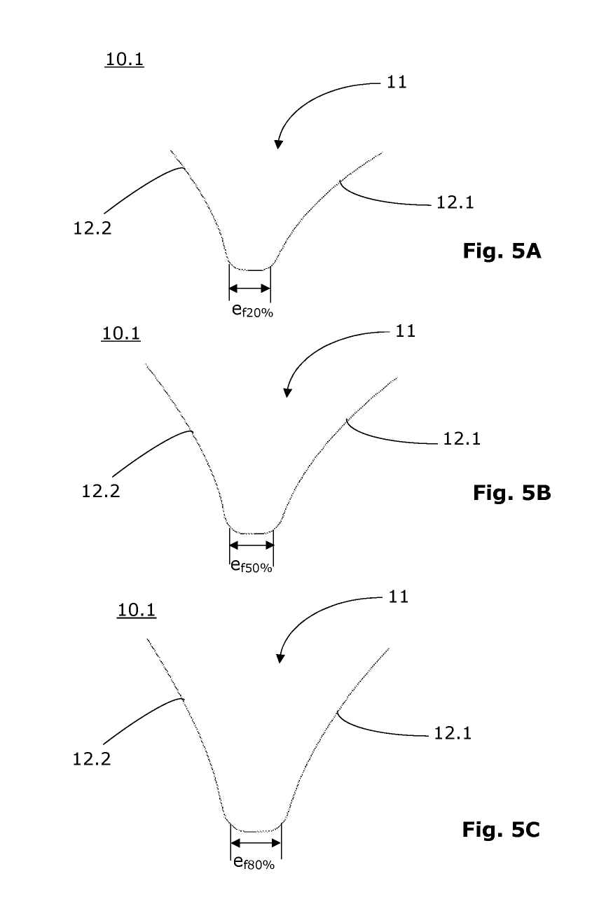

In FIGS. 5A-5C, this statement has been transferred to the tooth gap of a pinion 10.1, wherein these figures show transverse sections at a 20% tooth width, a 50% tooth width (i.e., in the tooth middle), and at an 80% tooth width. Since the pinion 10.1 has spiral gear teeth, the transverse sections differ from the normal sections. In the normal section, it would furthermore be true that the tooth gap base width is constant e_{fn}. I.e., the following relationship applies: e_{fn20%}=e_{fn50}%=e_{fn80}%. In the transverse section, in contrast, the tooth gap base widths e_{f} differ, as follows: e_{f20%}<e_{f50%}<e_{f80%}.

The flank longitudinal line of the corresponding crown wheel 10.3 of the hypoid gear gear teeth has the form of an epicycloid or is derived from an epicycloid.

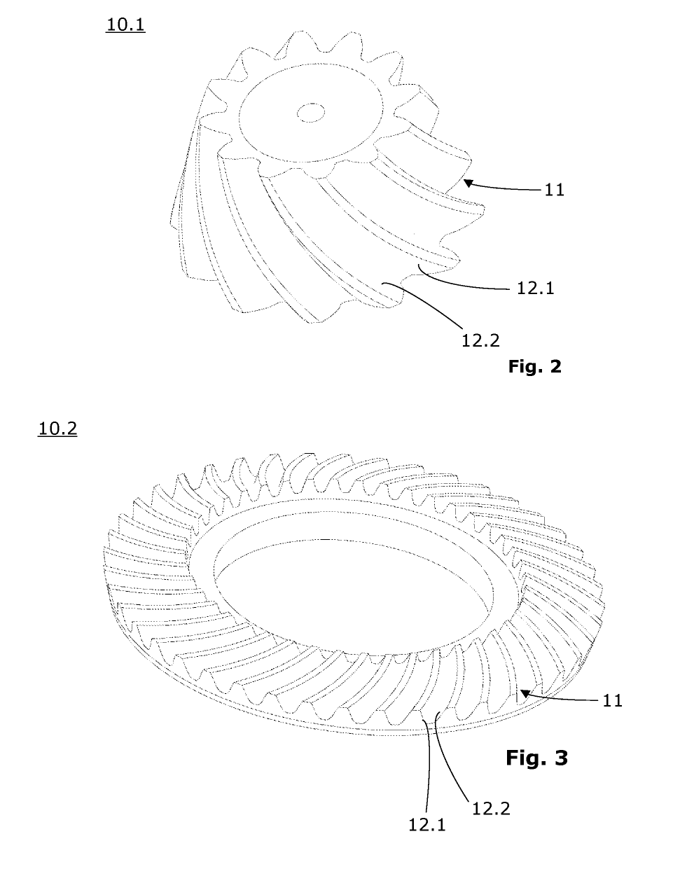

As can be inferred from FIGS. 1, 2, 3, and 5A-5C, bevel gears or hypoid gears 10, which have spiral gear teeth having at least one tooth gap 11. This at least one tooth gap 11 is delimited by tooth flanks 12.1, 12.2. The convex tooth flanks are identified with 12.1 in the figures and the concave tooth flanks are identified with 12.2. Each of these tooth flanks 12.1, 12.2 has a flank longitudinal line in the form of an epicycloid. In addition, the tooth gap 11 has a tooth gap base width e_{fn}, which is constant, as was already explained on the basis of FIG. 1.

The base cone angle and the head cone angle of the gear wheels 10 are intentionally selected or ascertained so that the tooth gap base width e_{fn} is constant in normal section. By selecting or ascertaining suitable base cone angles and head cone angles, a gear wheel 10 is obtained, in which the distance of the epicycloids of the concave flank 12.2 and the convex flank 12.1 in the gap base of the tooth gap 11 is constant in normal section. This statement also applies to lengthened and shortened epicycloids.

The tooth gaps 11 of the gear wheels 10 are defined by teeth which have a conical tooth shape, as can be recognized in the figures.

The teeth of the gear wheels 10 can have a tooth height Zh which varies along the tooth width. The tooth height Zh can also be constant in a special case, however.

A method for chip-removing manufacturing of at least one tooth gap of a bevel gear or hypoid gear workpiece can be used, which is executed in the continuous indexing method.

The indexing is thus performed continuously and all tooth gaps of a gear wheel 10 are generated quasi-simultaneously. Due to these coupled movements of the tool and the workpiece, an epicycloid results as the flank longitudinal line on the crown wheel 10.3 of the gear wheel 10 to be generated.

The invention may also be transferred to bevel gears or hypoid gears. In some such embodiments, the flank longitudinal line of which on the crown wheel 10.3 of the gear wheel to be generated is a hypocycloid.

What is claimed is:

1. An apparatus comprising:
a bevel gear or hypoid gear having spiral gear teeth, which have at least one tooth gap, wherein
the tooth gap is delimited by tooth flanks,
each of the tooth flanks has a flank longitudinal line in the form of an epicycloid, and
the tooth gap has a tooth gap base width (e_{fn}), which is constant.

2. An apparatus according to claim 1, wherein the tooth gap is defined by teeth which have a conical tooth shape.

3. An apparatus according to claim 2, wherein the teeth have a tooth height profile, configured so that the bevel gear or hypoid gear can be paired with a bevel crown gear or hypoid crown gear.

4. An apparatus according to claim 2, wherein the teeth have a tooth height (Zh) which varies along a tooth width.

5. An apparatus according to claim 1, wherein the tooth gap base width (e_{fn}) in normal section is equal at different positions of a tooth width.

6. An apparatus according to claim 2, wherein the tooth gap base width (e_{fn}) in normal section is equal at different positions of a tooth width.
